(19) United States
(12) Patent Application Publication
(10) Pub. No.: US 2026/0289359 A1
(43) Pub. Date: Sep. 24, 2026

(54) LEARNING DEVICE AND INFERENCE DEVICE

(71) Applicant: MITSUBISHI ELECTRIC CORPORATION, Tokyo (JP)

(72) Inventors: Satoru MATSUOKA, Tokyo (JP); Akio SAITO, Tokyo (JP); Shotaro AKAHO, Ibaraki (JP); Hideki ASO, Ibaraki (JP)

(73) Assignee: MITSUBISHI ELECTRIC CORPORATION, Tokyo (JP)

(21) Appl. No.: 19/490,962

(22) PCT Filed: Jan. 24, 2024
(86) PCT No.: PCT/JP2024/001965

§ 371 Date: Dec. 8, 2025

(30) Foreign Application Priority Data
Jun. 21, 2023 (JP) 2023-101736

(51) Int. Cl. G06N 7/00

(52) U.S. Cl. CPC G06N 7/00

(57) ABSTRACT

A learning device includes a data acquisition unit that obtains time-series sensor data observed during work, a data storage unit that stores data of each one trial of work obtained by the data acquisition unit, an identification time determination unit that determines a time suitable for making an identification of a predetermined anomaly, and a learning unit that selects a piece of data having a feature at the time determined by the identification time determination unit, and trains an anomaly identification model.

### FIELD

The present disclosure relates to a learning device and an inference device for use in anomaly diagnosis when a robot performs a work.

### BACKGROUND

Machine learning is used to diagnose an anomaly during work on the basis of time-series data from a control device of an industrial robot or the like. Not only to know whether normal or not normal, but also to identify an anomaly type, a technique has been proposed in which a large amount of data of a normal class is obtained, a normality model is trained, and a diagnosis is made again using a different technique, on data that has previously been diagnosed as anomalous using the normality model (see, e.g., Patent Literature 1).

### CITATION LIST

### Patent Literature

Patent Literature 1: Japanese Patent Application Laid-open No. 2018-24055

### SUMMARY OF INVENTION

### Problem to be Solved by the Invention

The technique of Patent Literature 1 uses the obtained data to perform learning without down-selection. Accordingly, training an accurate anomaly identification model on the basis of robot data that varies every trial of work requires to prepare a large amount of sample data for each type of anomaly to be identified.

The present disclosure has been made in view of the foregoing, and it is an object of the present disclosure to provide a learning device that enables reduction in the number of pieces of data of each type of anomaly for use in learning performed for identification of an anomaly.

### Means to Solve the Problem

To solve the problem and achieve the object described above, a learning device according to the present disclosure includes: a data acquisition unit that obtains time-series sensor data observed during work; a data storage unit that stores data of each one trial of work, obtained by the data acquisition unit; an identification time determination unit that determines a time suitable for making an identification of a predetermined anomaly; and a learning unit that selects a piece of data having a feature at the time determined by the identification time determination unit and that trains an anomaly identification model.

### Effects of the Invention

A learning device according to the present disclosure provides an advantageous effect in enabling reduction in the number of pieces of data of each type of anomaly for use in learning performed for identification of an anomaly.

### BRIEF DESCRIPTION OF DRAWINGS

FIG. 1 is a block diagram illustrating a configuration of a learning device according to a first embodiment.

FIG. 2 is a flowchart illustrating a procedure of an operation performed by a learning unit included in the learning device according to the first embodiment.

FIG. 3 is a block diagram illustrating a configuration of an inference device according to the first embodiment.

FIG. 4 is a block diagram illustrating a configuration of a learning device according to a second embodiment.

FIG. 5 is a block diagram illustrating a configuration of a learning device according to a third embodiment.

FIG. 6 is a block diagram illustrating a configuration of a learning device according to a fourth embodiment.

FIG. 7 is a block diagram illustrating a configuration of an inference device according to the fourth embodiment.

FIG. 8 is a block diagram illustrating a configuration of an inference device according to a fifth embodiment.

FIG. 9 is a diagram illustrating a processor when at least part of functionality of a sensor, a data acquisition unit, an identification time determination unit, and the learning unit included in the learning device according to the first embodiment is implemented in the processor.

FIG. 10 is a diagram illustrating a processing circuitry when at least part of functionality of the sensor, the data acquisition unit, the identification time determination unit, and the learning unit included in the learning device according to the first embodiment is implemented in the processing circuitry.

### DESCRIPTION OF EMBODIMENTS

A learning device and an inference device according to embodiments will be described in detail below with reference to the drawings.

### First Embodiment

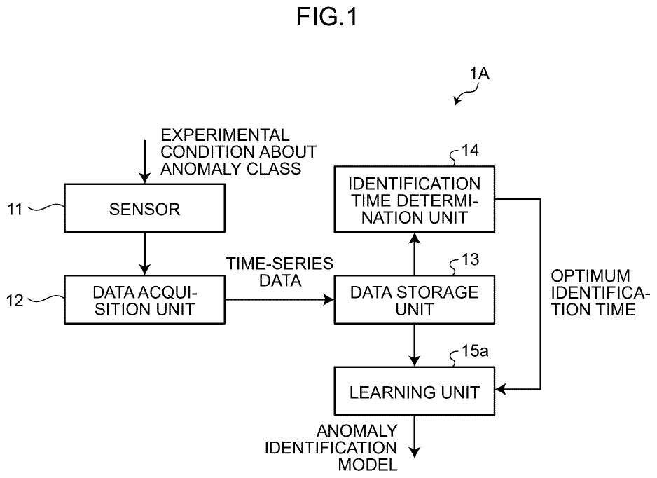

FIG. 1 is a block diagram illustrating a configuration of a learning device 1A according to a first embodiment. The learning device 1A includes a sensor 11, a data acquisition unit 12, a data storage unit 13, an identification time determination unit 14, and a learning unit 15a.

The sensor 11 is attached on a robot to measure, with a certain period, data observed during work. An example of the sensor 11 is a force sensor that measures values of force Fₓ, F_{y}, and F_{z} in three orthogonal axial directions and values of moment Mₓ, M_{y}, and M_{z} around three orthogonal axes, of a robot finger.

The sensor 11 measures data present when the robot is operated under a user-set normal condition and a user-set condition for intentionally causing an anomaly that is to be identified. Examples of the anomaly that is to be identified include an anomaly of a component such as partial loss or foreign matter inclusion, and an anomaly of a working position of a robot relative to peripheral equipment. FIG. 1 indicates the data to be measured by the sensor 11 by a phrase “experimental condition about anomaly class”.

The data acquisition unit 12 obtains time-series sensor data observed during work. For example, the data acquisition unit 12 obtains the data measured by the sensor 11 with a certain period, as the time-series data. The period of acquisition of data by the data acquisition unit 12 does not need to be the same as the measurement period of the sensor 11. The data acquisition unit 12 may simultaneously obtain data sets measured by multiple respective types of sensors 11, such as data measured by a force sensor and data of joint positions measured by encoders of the robot. When different ones of the sensors 11 perform measurement with different measurement periods, the data acquisition unit 12 may perform resampling to obtain data having synchronized time stamps.

The data storage unit 13 stores data of each one trial of work obtained by the data acquisition unit 12. For example, the data storage unit 13 stores time-series data of each one trial of work obtained by the data acquisition unit 12 together with a label that represents a class of normality or anomaly of a corresponding trial. The data storage unit 13 is implemented, for example, in a semiconductor memory.

The identification time determination unit 14 determines a time suitable for making an identification of a predetermined anomaly. For example, the identification time determination unit 14 calculates an optimum identification time Tₒₚₜ(i, c) of a sample data set “i” of a certain class c in the after-mentioned process flow of the learning unit 15a. An example of specific method of calculating the optimum identification time Tₒₚₜ(i, c) can be to use a p-value of t-test, which is known as a statistical test technique. In this method, the identification time determination unit 14 first determines, for each class c, a probability distribution q(c|xₖ) with respect to data xₖ at time k, used as a reference, from sample data including a specific number of pieces. The identification time determination unit 14 then obtains a probability that the probability distribution q(c′|xₖ) of a correct class c′ exceeds the probability distribution q(c|xₖ) of a class c other than the correct class c′, as the p-value of t-test. In this operation, the data section for use in evaluation may be a time section from the beginning of work to a certain time k, or the identification time determination unit 14 may use a sliding window having a time length ΔT to acquire data in a time section from time k-ΔT to time k. The optimum identification time Tₒₚₜ(i, c) can be a time when the p-value becomes minimum in the sample data set “i”. Alternatively, a threshold ε may be set, and a time when the p-value first falls below the threshold ε may be used as the optimum identification time Tₒₚₜ(i, c). As described above, the identification time determination unit 14 may determine the time suitable for making an identification of a predetermined anomaly on the basis of a probability distribution determined when data is observed during a time period from the beginning of work to a certain time. Alternatively, the identification time determination unit 14 may determine the time suitable for making an identification of a predetermined anomaly on the basis of a probability distribution determined when data is observed using a sliding window having a certain time length.

The learning unit 15a selects a piece of data having a feature at the time determined by the identification time determination unit 14, and trains an anomaly identification model. The term feature as used herein refers to a feature quantity for identifying an anomaly. In a case of time-series data, such feature appears at a time when values in different classes greatly differ from each other, and values in a same class relatively slightly differ from each other. The learning unit 15a may select data to be added for training, on the basis of uncertainty at the time determined by the identification time determination unit 14.

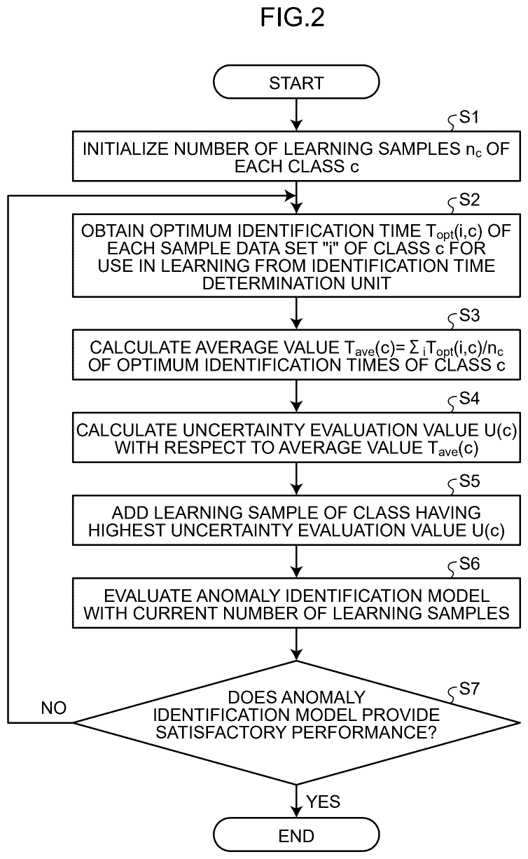

FIG. 2 is a flowchart illustrating a procedure of an operation performed by the learning unit 15a included in the learning device 1A according to the first embodiment. At step S1, the learning unit 15a initializes the number of learning samples no of each class c for use in identification. For example, the learning unit 15a initializes the numbers of learning samples as (class 0: the number of samples of normal, class 1: the number of samples of anomaly type 1, class 2: the number of samples of anomaly type 2, . . . )=(n₀, n₁, n₂, . . . ).

At step S2, the learning unit 15a obtains, from the identification time determination unit 14, the optimum identification time Tₒₚₜ(i, c) of each sample data set “i” of the class c for use in learning, using the foregoing method.

At step S3, the learning unit 15a calculates an average value Tₐᵥₑ(c) of all the optimum identification times Tₒₚₜ(i, c) of the class c. The average value Tₐᵥₑ(c) is expressed by Equation (1) below.

$$\begin{matrix}Formula 1 & \\ {T}_{ave} ( c ) = {\sum }_{i} {T}_{opt} ( i , c ) / {n}_{c} & ( 1 )\end{matrix}$$

At step S4, the learning unit 15a calculates an uncertainty evaluation value U(c) of the class c relating to the average value Tₐᵥₑ(c). The term uncertainty as used herein refers to a situation in which a data variation within a same class prevents a reliable assertion that the data belongs to the class c on the basis of a value at that time. Examples of specific method of calculating the uncertainty evaluation value U(c) include use of average entropy of the probability distribution q(c|xₖ) and use of an average value of the p-value. In addition, other usable selection criteria include an expected error reduction, which is proposed in a field of study of active learning.

At step S5, a learning sample of the class having a highest uncertainty evaluation value U(c) has been stored in the data storage unit 13, and the learning unit 15a selects and adds the learning sample of the class having the highest uncertainty evaluation value U(c) from sample data unused for training, and updates the value n_{c} as n_{c}←n_{c}+1. Addition of samples gradually reduces the uncertainty evaluation value U(c) calculated using the above method.

At step S6, the learning unit 15a performs machine learning using the updated number of learning samples, and evaluates the anomaly identification model obtained. FIG. 2 describes the operation at step S6 with a phrase “Evaluate anomaly identification model with current number of learning samples”. The learning unit 15a can use, in learning, any machine learning technique designed for classification problem. For example, the learning unit 15a can train, using logistic regression, a model that provides a posterior probability of “1” for a correct class and a posterior probability of “0” for other classes in a case of acquisition of certain time-series data. Alternatively, the learning unit 15a can train a model in which an output layer value set for data of class 0 is (1, 0, 0, . . . ), an output layer value set for data of class 1 is (0, 1, 0, . . . ), an output layer value set for data of class 0 is (0, 0, 1, . . . ), and so on, using neural network such as recurrent neural network (RNN). The learning unit 15a can use, for evaluation of the anomaly identification model, a ratio of correct anomaly identification with respect to sample data unused for training, or a cross entropy error, known as a loss function for classification problem.

At step S7, the learning unit 15a determines whether the anomaly identification model provides satisfactory performance. The determination may be made using a conditional expression that requires the ratio of correct anomaly identification to be greater than or equal to a predetermined value or the value of loss function such as a cross entropy error to be less than a predetermined value. When the learning unit 15a determines that a satisfactory performance is provided (Yes at S7), the learning unit 15a terminates learning, and stores the anomaly identification model. When the learning unit 15a determines that satisfactory performance is not provided (No at S7), the learning unit 15a causes the process to return to step S2, and examines which sample is to be added next for training.

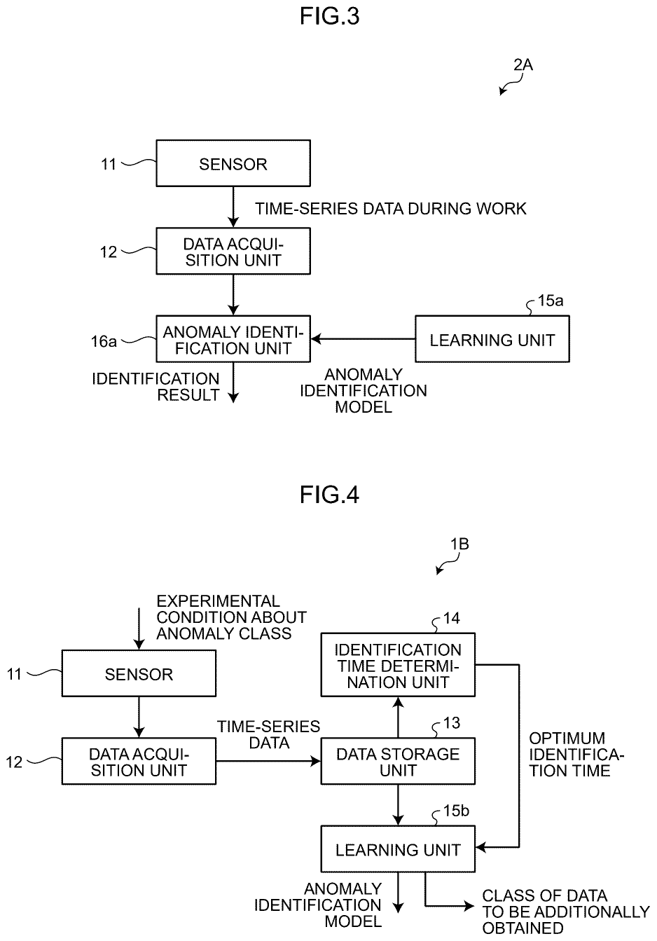

FIG. 3 is a block diagram illustrating a configuration of an inference device 2A according to the first embodiment. The inference device 2A makes an inference about an anomaly from time-series data observed during work using the anomaly identification model trained by the learning device 1A. The inference device 2A includes the sensor 11, the data acquisition unit 12, the learning unit 15a, and an anomaly identification unit 16a.

The sensor 11, the data acquisition unit 12, and the learning unit 15a of FIG. 3 are the same as those included in FIG. 1. The anomaly identification unit 16a uses the anomaly identification model obtained by the learning unit 15a, and identifies the anomaly type including whether normal or not normal, in association with time-series data obtained in a format similar to the format used in learning. For example, when the anomaly identification model trained using the above-mentioned logistic regression is used, the anomaly identification unit 16a can determine the class having a highest posterior probability value to be the identification result. The identification result may be output with a certain constant period during work of the robot, or may be output at a specific time point during work or upon completion of work.

As described above, the learning device 1A according to the first embodiment enables reduction in the number of pieces of data of each type of anomaly for use in learning performed for identification of an anomaly. The inference device 2A according to the first embodiment is capable of inferring an anomaly type using the anomaly identification model obtained by learning. Moreover, the inference device 2A is capable of identifying an anomaly type during work.

### Second Embodiment

FIG. 4 is a block diagram illustrating a configuration of a learning device 1B according to a second embodiment. The learning device 1B includes the sensor 11, the data acquisition unit 12, the data storage unit 13, the identification time determination unit 14, and a learning unit 15b. The sensor 11, the data acquisition unit 12, the data storage unit 13, and the identification time determination unit 14 are the same as those described in the first embodiment, and description thereof will therefore be omitted in the description of the second embodiment.

The process flow of learning performed by the learning unit 15b is the same as the process flow performed by the learning unit 15a included in the learning device 1A according to the first embodiment. That is, the learning unit 15b performs an operation with respect to learning using the procedure of the flowchart of FIG. 2. In the second embodiment, however, when the learning unit 15b adds a learning sample at step S5 of FIG. 2, the learning unit 15b obtains data of one trial of work by operating the robot once again, instead of adding a sample to be added for training, from the sample data already stored in the data storage unit 13 at the beginning of training. Thus, the learning unit 15b outputs an experimental condition, that is, a class of data to be newly obtained, which is data to be added for training on the basis of uncertainty of the time determined by the identification time determination unit 14.

The class of data to be additionally obtained may be determined in such a manner that the learning unit 15b determines the class having the highest uncertainty evaluation value U(c) obtained at step S4 of FIG. 2 to be the very exact class of data to be additionally obtained. Alternatively, in consideration of a risk that a piece of the sample data obtained by operating the robot once again may be an outlier or another similar value, the learning unit 15b can regard this problem as a multi-armed bandit problem, which is a problem that “when one arm is selected from slot machines and this arm is operated, a reward is given according to a certain probability”. The learning unit 15b can then use ε-greedy algorithm or upper confidence bound (UCB) algorithm, each of which is known as a selection algorithm for a multi-armed bandit problem.

The inference device that makes an inference using the anomaly identification model obtained by the learning device 1B according to the second embodiment has a configuration, and performs processing, the same as those of the inference device 2A according to the first embodiment, and description thereof will therefore be omitted.

As described above, the second embodiment enables training to be started when merely a small amount of sample data has been obtained, and a reduction to be achieved in the number of experiments for newly obtaining learning data.

### Third Embodiment

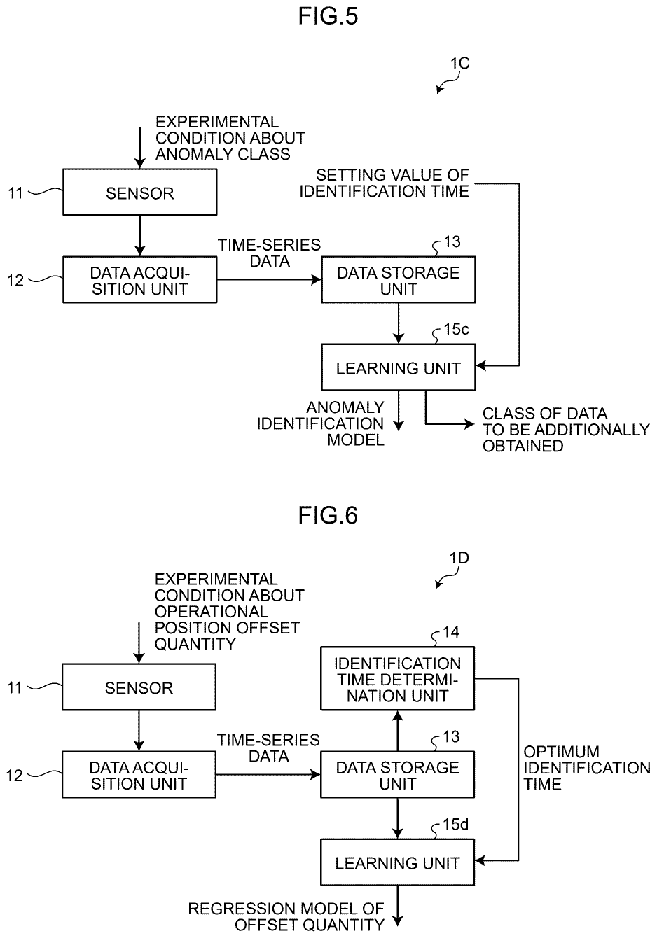

FIG. 5 is a block diagram illustrating a configuration of a learning device 1C according to a third embodiment. The learning device 1C includes the sensor 11, the data acquisition unit 12, the data storage unit 13, and a learning unit 15c. The sensor 11, the data acquisition unit 12, and the data storage unit 13 are the same as those described in the first embodiment, and description thereof will therefore be omitted in the description of the third embodiment.

The learning device 1C according to the third embodiment does not include the identification time determination unit 14. The learning unit 15c outputs a condition for newly obtaining the data to be added for training on the basis of uncertainty at a certain time of work. The learning unit 15c performs a process flow of learning in such a manner that the learning unit 15c sets an identification time predesigned for each class c, as the average value Tₐᵥₑ(c), instead of determining the average value Tₐᵥₑ(c) in time on the basis of the optimum identification time Tₒₚₜ(i, c), calculated by the identification time determination unit 14 respectively at steps S2 and S3 of FIG. 2. Alternatively, the learning unit 15c may set a completion time of one trial of work as the average value Tₐᵥₑ(c) common to a class. The process flow of learning after this step is the same as that of the second embodiment, and description thereof will therefore be omitted.

The inference device that makes an inference using the anomaly identification model obtained by the learning device 1C according to the third embodiment has a configuration, and performs processing, the same as those of the inference device 2A according to the first embodiment, and description thereof will therefore be omitted.

As described above, even when an anomaly identification model at a predesigned identification time is to be trained, the third embodiment enables training to be started when merely a small amount of sample data has been obtained, and a reduction to be achieved in the number of experiments for newly obtaining learning data.

### Fourth Embodiment

FIG. 6 is a block diagram illustrating a configuration of a learning device 1D according to a fourth embodiment. The learning device 1D includes the sensor 11, the data acquisition unit 12, the data storage unit 13, the identification time determination unit 14, and a learning unit 15d. The sensor 11, the data acquisition unit 12, the data storage unit 13, and the identification time determination unit 14 are the same as those described in the first embodiment, and description thereof will therefore be omitted in the description of the fourth embodiment.

The fourth embodiment differs from the first embodiment in that time-series data is obtained at an operational position that has been offset from a reference position, as an anomaly, and a regression model of the offset quantity is trained. In the fourth embodiment, the anomaly is an offset of an operational position from a reference position, and the anomaly identification model trained by the learning unit 15d is a regression model of the offset quantity. The process flow of learning performed by the learning unit 15d is similar to the process flow of FIG. 2. The learning device 1D uses the direction of offset as class c, where the direction of offset is, for example, a translational direction or a rotational direction with respect to the surface on which assembly work is performed. The learning device 1D then stores time-series data of each one trial of work in the data storage unit 13 together with a correct value of offset quantity. The identification time determination unit 14 calculates the optimum identification time Tₒₚₜ(i, c) of the sample data set “i” of the class c.

At step S6 of FIG. 2, in which machine learning is performed, the learning unit 15d can obtain a model for identifying the offset quantity and the direction of the offset quantity using a machine learning technique designed for regression problem. For example, the learning unit 15d can learn a relationship between sensor data and the offset quantity at the identification time Tₐᵥₑ(c) using Gaussian process regression (GPR), which is a technique used in inference of a nonlinear function y=f(x). Alternatively, the learning unit 15d can also train a model including an output layer having a first node corresponding to a transitional offset quantity in an X direction, a second node corresponding to a transitional offset quantity in a Y direction, and so on, using neural network such as RNN.

In the fourth embodiment, the learning device 1D is also capable of outputting an experimental condition for additionally obtaining data from the learning unit 15d by combining with the technique described in the second embodiment. For example, the learning device 1D can determine sample data to be added of which offset direction, i.e., of which class c, using the technique described in the second embodiment, and determine an experiment to be performed with how much offset in that direction, using Bayesian optimization, which is known as an algorithm that updates an acquisition function and selects a next exploration point, on the basis of a result of Gaussian process regression.

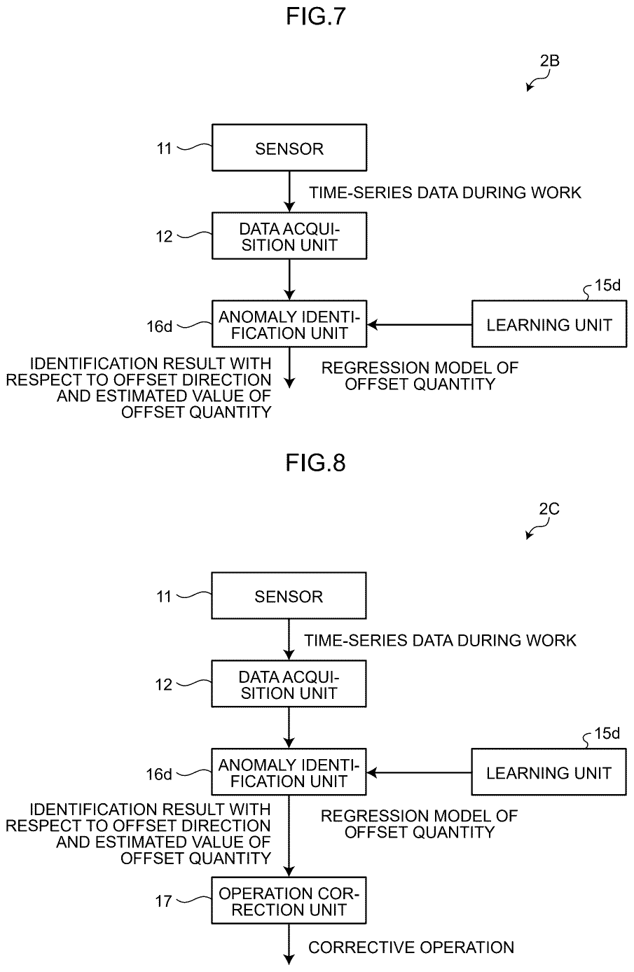

FIG. 7 is a block diagram illustrating a configuration of an inference device 2B according to the fourth embodiment. The inference device 2B makes an inference using the anomaly identification model obtained by the learning device 1D. Moreover, the inference device 2B infers an offset quantity from time-series data observed during work using the regression model trained by the learning device 1D. The inference device 2B includes the sensor 11, the data acquisition unit 12, the learning unit 15d, and an anomaly identification unit 16d. The anomaly identification unit 16d uses the regression model obtained by the learning unit 15d, and outputs an identification result with respect to the offset direction and an estimated value of the offset quantity, in association with time-series data obtained in a format similar to the format used in learning.

As described above, even for a problem of identification, as an anomaly, of an offset of the operational position that may appear during repeated work, the fourth embodiment enables a reduction to be achieved in the number of pieces of data for use in learning, and moreover, a current offset quantity to be inferred during work. Similarly to the third embodiment, a configuration that does not include the identification time determination unit 14 is also applicable to this embodiment.

### Fifth Embodiment

FIG. 8 is a block diagram illustrating a configuration of an inference device 2C according to a fifth embodiment. The inference device 2C includes, similarly to the inference device 2B according to the fourth embodiment, the sensor 11, the data acquisition unit 12, the learning unit 15d, and the anomaly identification unit 16d, and further includes an operation correction unit 17, which corrects the current operational position on the basis of the offset quantity inferred.

The fifth embodiment is characterized in making a correction toward normal operation during work, that is, before a complete stop of operation due to an error, on the basis of an anomaly identification result obtained using the anomaly identification model obtained by the learning device 1D according to the fourth embodiment. An identification result with respect to the offset direction and an estimated value of the offset quantity, relative to an operational position that will provide normal operation, are obtained as outputs from the anomaly identification unit 16d, and as such, addition of an amount of correction to cancel the offset to an operational position command for the robot enables operation correction to be provided. To prevent worsening the error state by overcorrection, the operation correction unit 17 may be designed to output a reduced amount of correction depending on the degree of uncertainty of the estimated value represented by, for example, a value of a kernel function when Gaussian process regression is used.

As described above, the fifth embodiment enables the current operational position to be corrected to a correct position during work. In addition, even when the anomaly identification model is used that learns only a class of an anomaly, obtained by one of the learning devices 1A, 1B, and 1C according to the first through third embodiments, the inference device 2C can select an operation such as discarding of an anomalous part or returning the finger position to the origin, correspondingly to the anomaly identification result, by using the operation correction unit 17.

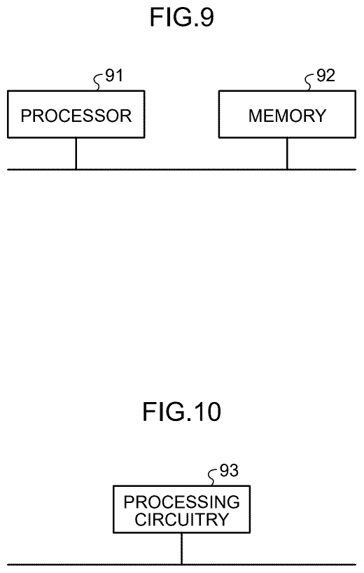

FIG. 9 is a diagram illustrating a processor 91 when at least part of the functionality of the sensor 11, the data acquisition unit 12, the identification time determination unit 14, and the learning unit 15a included in the learning device 1A according to the first embodiment is implemented in the processor 91. That is, at least part of the functionality of the sensor 11, the data acquisition unit 12, the identification time determination unit 14, and the learning unit 15a may be implemented in the processor 91, which executes a program stored in a memory 92. The processor 91 is a central processing unit (CPU), a processing system, a computing system, a microprocessor, or a digital signal processor (DSP). FIG. 9 also illustrates the memory 92.

When at least part of the functionality of the sensor 11, the data acquisition unit 12, the identification time determination unit 14, and the learning unit 15a is implemented in the processor 91, the at least part of the functionality is implemented in the processor 91 and software, firmware, or a combination of software and firmware. The software or firmware is described in the form of a program, and is stored in the memory 92. The processor 91 reads and executes a program stored in the memory 92 to provide the at least part of the functionality of the sensor 11, the data acquisition unit 12, the identification time determination unit 14, and the learning unit 15a.

When at least part of the functionality of the sensor 11, the data acquisition unit 12, the identification time determination unit 14, and the learning unit 15a is implemented in the processor 91, the learning device 1A includes the processor 91 and the memory 92 for storing a program that causes at least part of the steps that are to be performed by the sensor 11, the data acquisition unit 12, the identification time determination unit 14, and the learning unit 15a to be performed. It can also be said that the program stored in the memory 92 causes a computer to perform at least part of procedure or method to be performed by the sensor 11, the data acquisition unit 12, the identification time determination unit 14, and the learning unit 15a.

The memory 92 is, for example, a non-volatile or volatile semiconductor memory such as a random access memory (RAM), a read-only memory (ROM), a flash memory, an erasable programmable read-only memory (EPROM), or an electrically erasable programmable read-only memory (EEPROM) (registered trademark); a magnetic disk, a flexible disk, an optical disk, a compact disc, a MiniDisc, a digital versatile disk (DVD), or the like.

FIG. 10 is a diagram illustrating a processing circuitry 93 when at least part of the functionality of the sensor 11, the data acquisition unit 12, the identification time determination unit 14, and the learning unit 15a included in the learning device 1A according to the first embodiment is implemented in the processing circuitry 93. That is, at least part of the functionality of the sensor 11, the data acquisition unit 12, the identification time determination unit 14, and the learning unit 15a may be implemented in the processing circuitry 93.

The processing circuitry 93 is a dedicated hardware element. The processing circuitry 93 is, for example, a single circuit, a set of multiple circuits, a programmed processor, a parallel programmed processor, an application specific integrated circuit (ASIC), a field-programmable gate array (FPGA), or a combination thereof.

Part of the functionality of the sensor 11, the data acquisition unit 12, the identification time determination unit 14, and the learning unit 15a may be implemented in a dedicated hardware element different from a dedicated hardware element that implements the rest.

Multiple functionalities of the sensor 11, the data acquisition unit 12, the identification time determination unit 14, and the learning unit 15a may be implemented in such a manner that part of the multiple functionalities are implemented in software or firmware, and the rest of the multiple functionalities is implemented in a dedicated hardware element. As described above, the multiple functionalities of the sensor 11, the data acquisition unit 12, the identification time determination unit 14, and the learning unit 15a can be implemented in hardware, software, firmware, or a combination thereof.

At least part of the functionality of the sensor 11, the data acquisition unit 12, the learning unit 15a, and the anomaly identification unit 16a included in the inference device 2A according to the first embodiment may be implemented in a processor or a processing circuitry. This processor is a processor equivalent to the processor 91. This processing circuitry is a processing circuitry equivalent to the processing circuitry 93.

At least part of the functionality of the sensor 11, the data acquisition unit 12, the identification time determination unit 14, and the learning unit 15b included in the learning device 1B according to the second embodiment may be implemented in a processor or a processing circuitry. This processor is a processor equivalent to the processor 91. This processing circuitry is a processing circuitry equivalent to the processing circuitry 93.

At least part of the functionality of the sensor 11, the data acquisition unit 12, and the learning unit 15c included in the learning device 1C according to the third embodiment may be implemented in a processor or a processing circuitry. This processor is a processor equivalent to the processor 91. This processing circuitry is a processing circuitry equivalent to the processing circuitry 93.

At least part of the functionality of the sensor 11, the data acquisition unit 12, the identification time determination unit 14, and the learning unit 15d included in the learning device 1D according to the fourth embodiment may be implemented in a processor or a processing circuitry. This processor is a processor equivalent to the processor 91. This processing circuitry is a processing circuitry equivalent to the processing circuitry 93.

At least part of the functionality of the sensor 11, the data acquisition unit 12, the learning unit 15d, and the anomaly identification unit 16d included in the inference device 2B according to the fourth embodiment may be implemented in a processor or a processing circuitry. This processor is a processor equivalent to the processor 91. This processing circuitry is a processing circuitry equivalent to the processing circuitry 93.

At least part of the functionality of the sensor 11, the data acquisition unit 12, the learning unit 15d, the anomaly identification unit 16d, and the operation correction unit 17 included in the inference device 2C according to the fifth embodiment may be implemented in a processor or a processing circuitry. This processor is a processor equivalent to the processor 91. This processing circuitry is a processing circuitry equivalent to the processing circuitry 93.

The configurations described in the foregoing embodiments are merely examples. These configurations may be combined with another known technology, and configurations of different embodiments may be combined together. Moreover, such configurations may be partly omitted and modified without departing from the gist.

### REFERENCE SIGNS LIST

1A, 1B, 1C, 1D learning device; 2A, 2B, 2C inference device; 11 sensor; 12 data acquisition unit; 13 data storage unit; 14 identification time determination unit; 15a, 15b, 15c, 15d learning unit; 16a, 16d anomaly identification unit; 17 operation correction unit; 91 processor; 92 memory; 93 processing circuitry.

1. A learning device comprising:
a learning circuitry to train an anomaly identification model on a basis of data having a feature at a time suitable for making an identification of an anomaly in time-series sensor data.

2. The learning device according to claim 1,
further comprising an identification time determining circuitry to determine the time suitable for making an identification, on a basis of a probability distribution determined when data is observed until a certain time.

3. The learning device according to claim 1,
further comprising an identification time determining circuitry to determine the time suitable for making an identification, on a basis of a probability distribution determined when data is observed using a sliding window having a certain time length.

4. The learning device according to claim 1, wherein
the learning circuitry selects data to be added for training, on a basis of uncertainty at the time suitable for making an identification.

5. The learning device according to claim 1, wherein
the learning circuitry outputs a condition for newly obtaining data to be added for training on a basis of uncertainty at the time suitable for making an identification.

6. (canceled)

7. An inference device that makes an inference about an anomaly from the time-series sensor data using the anomaly identification model trained by the learning device according to claim 1.

8. The learning device according to claim 1, wherein
the anomaly is an offset of an operational position from a reference position, and
the anomaly identification model trained by the learning circuitry is a regression model of an offset quantity.

9. An inference device that infers an offset quantity from the time-series sensor data using the regression model trained by the learning device according to claim 8.

10. The inference device according to claim 9, comprising
an operation correcting circuitry to correct a current operational position on a basis of the offset quantity inferred.
